(19) United States
(12) Patent Application Publication
(10) Pub. No.: US 2026/0219552 A1
(43) Pub. Date: Jul. 30, 2026

(54) SURROUND-VIEW IMAGING SYSTEM WITH INTEGRATED WIDE ANGLE ILLUMINATOR

(71) Applicant: Jabil Optics Germany GmbH, Jena (DE)

(72) Inventor: Andreas Bock, Jena (DE)

(73) Assignee: Jabil Optics Germany GmbH, Jena (DE)

(21) Appl. No.: 19/146,093

(22) PCT Filed: Feb. 15, 2023
(86) PCT No.: PCT/EP2023/053812

§ 371 Date: Jul. 7, 2025

(51) Int. Cl. G03B 15/03; G03B 37/00

(52) U.S. Cl. CPC G03B 15/03; G03B 37/00

(57) ABSTRACT

The present invention refers to a surround-view imaging system for three-dimensional (3D) imaging of a surrounding of the system, and in particular to a surround-view imaging system comprising an integrated wide angle illuminator. A surround-view imaging system according to the present invention comprises an imager and an illuminator; wherein the illuminator comprises a light source and a diffusor that provide an illumination light with a batwing intensity profile, wherein the illumination light is directed towards the imager in a vertical direction; and a deflector positioned between the light source and imager in the vertical direction, configured to redirect the illumination light from the vertical direction to essentially a horizontal direction in a field of view of the imager, wherein a field of view of the illuminator and the field of view of the imager at least partly overlap in a surrounding of the system.

### CROSS REFERENCE TO RELATED APPLICATION(S)

This application is a national stage 371 application of PCT/EP2023/053812, filed Feb. 15, 2023, the entire disclosure of which is hereby incorporated by reference.

### TECHNICAL FIELD

The present invention refers to a surround-view imaging system for three-dimensional (3D) imaging of a surrounding of the system, and in particular to a surround-view imaging system comprising an integrated wide angle illuminator.

### BACKGROUND

For 3D imaging systems or sensors which can locate objects in a 3D surrounding of the system, there are different approaches available which are based on various technologies such as light detection and ranging (LiDAR), time of flight (TOF, direct and indirect versions), amplitude or frequency modulated illumination, structured light, etc. Such systems can typically be found in autonomous mobile robots (AMRs), industrial mobile robots (IMRs), and automated guided vehicles (AGVs) like lift trucks, forklifts, cars, drones, etc. to avoid collisions, to detect obstacles, for passenger monitoring and for observing keep-out-zones for machines and robots. Surround-view imaging systems can also be used for collaborative robotics, security and surveillance camera applications.

A typical TOF depth sensing system consists of an illumination system including beam forming (e.g., electronic and/or optical beam forming in a temporal and/or spatial manner), an imaging system comprising receiving optics (e.g., a single lens or a lens system/objective) and an image detector for image detection. Furthermore, evaluation electronics for calculating the distances and may be setting some alarms based on a detected image signal may be comprised. The illuminator typically sends out modulated or pulsed light. The distance of an object can be calculated from the time the emitted light requires for traveling from the illumination system to the object and back to the imaging system. Optical beam forming can be achieved by a beam shaping optics included in the illumination system. The beam shaping optics and the receiving optics can be separate optical elements (one-way optics) or the beam shaping optics and the receiving optics can use single, multiple or all components of the corresponding optics commonly (two-way optics).

When an imaging solution based on wide-field lens optics is used in combination with a fixed array detector for image detection (e.g., CMOS, CCD, array of photodiodes, etc.), moving and therefore particularly error-prone scanner units can be completely avoided in the systems.

A surround-view image can be generated by using a wide-angle lens (e.g., a fisheye lens or rectilinear lens) as first lens of a lens system in a corresponding imaging system. Wide-angle lenses can have an angle of view (AOV), e.g., the maximum zenithal angle range in a vertical direction for which a lens can provide an image, of more than 180°. Lenses with an AOV of more than 180° are called ultra wide-angle lenses. Angles of view up to around 300° can be achieved. In a typical axially symmetric imaging system, the imageable azimuthal angle range, e.g., in a horizontal direction, is typically 360°, which allows surround-view in the azimuthal direction. Therefore, with an ultra wide-angle lens solid angles Ω of up to around 3π steradian can be imaged. Wide-angle lenses typically show a strong curvilinear barrel distortion, which can to some degree optically corrected in rectilinear lenses. An optical barrel distortion correction can also be included in the design of an associated lens system. Lens systems with an AOV larger than 180° are accordingly called ultra wide-angle lens systems.

Especially for AMR, IMR and AGV applications, an azimuthal angle range Δθ of 360° in the horizontal plane at high zenith angles φ in a range between 60° and 120° is typically required. For such purposes a fisheye lens may be used in the upright position. However, conventional fisheye lenses have several disadvantages, such as high angles of incidence and associated coating problems. Further problems are a very wide field of view in combination with low resolution, low f-number and vignetting caused by offset illumination.

Optimized fisheye-type lenses (e.g., a catadioptric lens system) with a wide horizontal field of view (FOV) but limited vertical FOV are typically imaging the surrounding of the system onto a circular ring in the image plane of the imaging system. A two-dimensional array detector (e.g. CMOS, CCD, array of photodiodes, etc.), which may completely cover the circular image, can be used to detect the image of the surrounding. But also for standard fisheye-lenses and other lenses without an optimized FOV region, the readout of the image detector can be limited to specific zenithal or azimuthal angle ranges, and in particular also to a circular ring comparable to a circular image region of said optimized fisheye-type lenses. With such a spatially limited detection, incorrect depth signals caused from multi-reflected illumination light or image detector saturation can be avoided.

Illumination light can be provided by an illuminator which should preferably be able to illuminate the complete FOV of the imager by the respective FOV of the illuminator. However, at last a partly overlap between the two FOV may be required. Existing system aligned in the upright position typically use multiple light sources to illuminate a 360° FOV in the horizontal direction (i.e. in the horizontal FOV) or use mechanical elements (e.g., MEMS) to sequentially illuminate a scene in the surrounding of the system. However, mechanical systems should be avoided due to their limited durability and resilience, in particular for applications in robots and other autonomous devices. The use of several light sources increases the manufacturing costs and complexity of the systems.

The objective problem of the invention is thus related to the problem of providing an illuminator allowing to illuminate a 360° FOV of a surround view imagining system at low costs, that is less complex compared to prior art illuminators and which provides high durability and resilience.

### SUMMARY

The invention solves the objective problem by providing a surround-view imaging system as defined in claim 1.

The surround-view imaging system for imaging a surrounding of the system according to the present invention comprises an imager and an illuminator; wherein the illuminator is adapted to illuminate in a field of view of the illuminator the surrounding of the system such that illumination light that is reflected by the surrounding can be imaged by the imager in a field of view of the imager as imaging light, wherein the illuminator and the imager are arranged one over another in a vertical direction essentially parallel to a vertical axis of the system (e.g., along the optical axis of the imager), wherein the system is configured to allow circumferential imaging in a horizontal plane (i.e., 360° horizontal FOV in the azimuthal direction) perpendicular to the vertical axis in the field of view of the imager (the height of the imaging is defined by the vertical FOV in the zenithal direction). The illuminator comprises a light source and a diffusor that provide the illumination light with a batwing intensity profile, wherein the illumination light is directed towards the imager in the vertical direction; and a deflector positioned between the light source and imager in the vertical direction, configured to redirect the illumination light from the vertical direction to essentially a horizontal direction in the field of view of the imager (includes diverging beams in the zenithal direction above and below a central direction of the essentially horizontally deflected light to allow completely addressing the vertical FOV), wherein the field of view of the illuminator and the field of view of the imager at least partly overlap in the surrounding.

An imager is to be understood as a device which is able to receive, focus and detect imaging light entering the imager from a surrounding of the imager. It therefore typically comprises at least an (preferably ring-shaped circumferential) 360° entrance aperture adjacent to the surrounding, a lens or other optical element to generate an image of the surrounding and an associated image detector to detect the generated image of the surrounding for further processing. Since the generation of the image is the far most critical aspect for ensuring a good image quality, instead of using a single lens or optical element, lens systems (or optical component systems in general) for the correction of occurring aberrations may be used in an imager. An imager can be a device which uses ambient light for imaging (e.g., 3D visible or infrared light) or may be specifically adapted to image reflected light from an illumination light source or illuminator (illumination light) as imaging light (e.g., flash LIDAR).

Preferably, an imager including a lens system (or a single lens) is further adapted to image around the optical axis of the lens system (axially symmetric imaging) in an image on an image plane perpendicular to the optical axis of the lens system. However, some components of the lens system may also be arranged off-axial or the image plane could be shifted and/or tilted with respect to the optical axis of the optical system. Such embodiments allow an increased flexibility for matching the FOV of the imaging system to a specific region of interest (ROI) especially in TOF depth sensing applications.

An illuminator is to be understood as a device which is able to emit illumination light in a surrounding of the illuminator. In a surround-view imaging system, an illuminator may provide a bright light impulse, which is reflected by objects in the surrounding and which then can be imaged as imaging light by an imager (e.g., flash LIDAR) having an associated image detector. However, an illuminator can also be configured to provide a temporally and/or spectrally well-defined light field which is also reflected by objects in the surrounding of the illuminator and which can be imaged afterwards more specifically (e.g., LiDAR/LaDAR or TOF). The term illuminator is therefore not restricted to a specific type of light source or a specific type of illumination for the surrounding. The discussed types of surround view imaging systems are usually referred to as active imaging systems. In contrast, passive surround-view imaging systems are designed to use only ambient light for imaging and therefore they do not require an illuminator as an essential component.

The FOV of the illuminator and the FOV of the imager should at least partly overlap to allow the reflected illumination light to be received as imaging light. However, to avoid saturation and overexposure of an associated image detector, the two FOV can be adapted to differ from one another or to include different FOV regions. However, it is highly preferred that the FOV of the imager and the respective FOV of the illuminator are identical or at least have only a very small distance to each other to avoid a complex angle correction for evaluating.

Preferably, the illuminator is arranged above a lens of the imager (e.g., a 360° lens as first lens of the imager) in the vertical direction. The field of view of the lens and the deflector preferably comprise an azimuthal angle θ of 360° in the horizontal plane (i.e., providing a 360° horizontal FOV). However, the present invention is not limited to a 360° surround view imaging system. Depending on the specific requirements of an application, the effective FOV of a corresponding surround view imaging system could also be limited accordingly.

Preferably, the diffusor is arranged above an emitter surface of a semiconductor light source. The semiconductor light source may be a vertical cavity surface emitting laser (VCSEL). The emitter surface may be planar surface. A planar emitter may provide a beam with a symmetric beam profile. A symmetric beam profile is preferred since in this case the diffusor can be symmetric as well and has not to be optimized and carefully alight to a specific axis of the emitter during system assembly.

Preferably, the diffusor is configured for converting a circular input beam into a substantially annular output beam (rotationally symmetric batwing intensity profile), wherein the maximum intensity in the annular region of the output beam having high intensity is exceeding a maximum intensity in the central region of the annular output beam having low intensity by at least a factor of 2. For an ideal batwing intensity profile, the center region of the annular output beam has zero intensity and thus all intensity of the beam is located in the annular region around the center region. However, real batwing intensity profiles typically still have a non-zero intensity distribution in the inner region of the annular output beam resulting from an imperfect beam shaping or transition. However, a typical batwing intensity profile may be characterized by two separate high intensity peaks (with a specific width, e.g., a FWHM width) in a cross section of the beam and which appear rotationally symmetric around the center of the annular beam profile.

Preferably, the diffusor is basically a half-shell including a circular wing structure forming a crown around the apex of the diffusor. The circular wing structure and the crown may be symmetrically formed around a central axis of the diffusor. The interior of the half-shell-shaped diffusor is preferably filled with a solid index material. However, also gaseous or liquid index materials may be used. The interior of the half-shell-shaped diffusor may also be non-filled (evacuated) or the interior is integrally formed with the material of the half-shell-shaped structure (hemispherical structure). In an alternative preferred embodiment, the diffusor may be an diffractive optical element (DOE). These optical elements can provide a symmetric output beam even from an asymmetric input beam. Further beam shaping features can be integrated in DOE. For surface relief DOE, microstructure replication techniques such as embossing, molding and casting can be used for easy and cost-effective fabrication.

Preferably, the outer shape of the deflector corresponds to that of a cone section (e.g., a section of a right circular cone or an oblique circular cone) or is a freeform shape. While a deflector based on a relatively simple cone section may only reflect the beam profile provided by the diffusor under limited angles, a freeform shape allows to define spatially dependent deflection angles in the complete FOV. Furthermore, a deflector based on a freeform shape can be used for further beam shaping and further modifying the intensity distribution of the incoming beam. In particular, the batwing intensity profile of the diffusor and an angle-dependence of the deflection of the deflector may be configured such that an essentially homogeneous illumination of the field of view of the imager is cooperatively achieved.

Preferably, the diffusor and the deflector are configured to prevent directly scattered illumination light from entering the imager. This may be achieved by ensuring that light cannot enter the imager without being reflected by the surrounding of the system before.

Preferably, the intensity of the illumination light in the field of view of the illuminator has a maximum at an azimuthal angle θ between of 80° and 90° and a full width at half maximum (FWHM) azimuthal angle Δθ_{FWHM} between 10° and 40°. These angle ranges are typically required for applications in robots and for other autonomous systems.

Preferably, the image detector may have an active detection region which is adapted to the image size or a specifically defined region of interest (ROI). As the central region of the image, which may correspond to zenithal angles outside the effective FOV of the imager, may not be relevant for imaging, these regions of the image detector can be completely omitted or neglected from image readout or by a selective mapping with an effective active detector surface. This has the advantage that otherwise passive regions of the image detector cannot be saturated by accidentally captured ambient and scattered light. Furthermore, due to the fact that no readout of insignificant detector regions has to be performed, the effective frame rates of a specific type of detector may be increased for specific detector configurations. Through higher frame rates, the accumulation of optically induced charge carriers in the individual pixels of a detector can be reduced such that the signal-to-noise ratio (SNR) of the detector can be optimized for image detection over a wide dynamic range without using high dynamic range (HDR) techniques.

An illuminator according to the present invention enables to illuminate a 360° horizontal FOV of the surround view imaging system with only a single light source. The single light source may be mounted above the optical axis of the imager directly on top of a first 360° lens of the imager. It may use a customized, extreme batwing diffusor profile to illuminate the deflector, which essentially deflects the light to the 360° horizontal FOV. Any non-deflected light may be used to illuminate lower parts of a scene in the surrounding within the vertical FOV of imager. The light which is deflected may be used to illuminate the higher parts of that scene in the surrounding instead.

The combination of a customized diffusor and a customized deflector can be optimized for a specifically required vertical FOV and to prevent stray light to enter into the 360° lens. Using only a single light source simplifies the electrical/thermal design of the surround view imaging system, the calibration process and the timing alignment (especially in TOF systems). Since only a single light source will be enough to illuminate a horizontal view of 360°, a smaller form factor, less critical electrical/thermal requirements, and lower costs may result. The system performance can be increased since a timing alignment between different light sources, as they are typically used in the prior art illuminator designs, is not required anymore.

Further preferred embodiments of the invention result from features mentioned in the dependent claims.

The various embodiments and aspects of the invention mentioned in this application can be combined with each other to advantage, unless otherwise specified in the particular case.

### BRIEF DESCRIPTION OF THE DRAWINGS

In the following, the invention will be described in further detail by figures. The examples given are adapted to describe the invention. The figures show:

FIG. 1 a schematic illustration of an exemplarily embodiment of an imager according to the prior art;

FIG. 2 a) a schematic illustration of a light source with a diffusor according to the present invention and b) an exemplarily batwing intensity profile generated by a surround-view imaging system according to the present invention;

FIG. 3 a schematic illustration of exemplarily embodiment of a surround-view imaging system according to the present invention; and

FIG. 4 schematic illustrations for using different alignments of the images on the detector to optimize image resolution and FOV of the imager of a surround-view imaging system.

### DETAILED DESCRIPTION

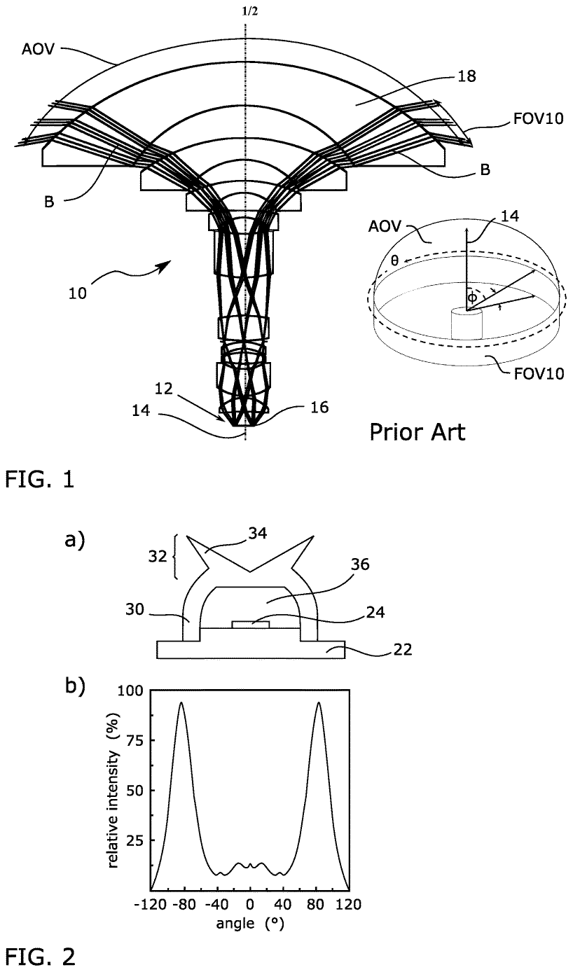

FIG. 1 shows a schematic illustration of an exemplarily embodiment of an imager 10 according to the prior art. The calculated ray paths inside the optical system of the imager 10 for imaging light B which is received from an imaging region are shown. The imager 10 comprises a lens stack with multiple fisheye-type lenses forming a continuous field of view of the imager FOV10. For example, the imaging region may cover zenithal angles φ between 60° and 120°. In the inset of the figure, the definition of the zenithal angles φ and azimuthal angles θ with respect to the optical/vertical axis 14 of the imager 10 are illustrated.

The exemplarily shown lens system 10 is fully refractive and may consist of 10 glass lenses, including a first lens 18 for collecting the imaging light B. However, the number of lenses and the material type may vary. In particular, the shown lens system is designed for a vertical FOV of 20° starting at a zenithal angle φ of 80°. All received optical beams are focused so that an image 16 of the surroundings is imaged on a common image plane/detector 12, which can be aligned perpendicular to the optical axis 14 of the imager 10.

The image 16 projected on the image plane/detector 12 may be a annular image but could be smaller, larger or take a different shape depending on the illumination and lens design of the imager 10. Further, the detector setup or image detector readout can be limited to specific ROI restricting the volume of the surrounding which can be imaged.

FIG. 2 shows a) a schematic illustration of a light source 24 with a diffusor 30 according to the present invention and b) an exemplarily batwing intensity profile generated by a surround-view imaging system according to the present invention. The light source 24 may be, for example, a single light emitting diode (LED) or diode laser (e.g. VCSEL), which may be mounted on a substrate 22. The diffusor 30 may be arranged above an emitter surface of the light source 24. The light source 24 and the diffusor 30 shall provide illumination light with a batwing intensity profile. Therefore, the diffusor 30 may be configured for converting a circular input beam of the light source 24 into a substantially annular output beam, wherein the maximum intensity in the annular region of the output beam having high intensity is significantly exceeding a maximum intensity in the central region of the annular output beam having low intensity, preferably by at least a factor of 2. The circular input beam may be a divergent beam. The substantially annular output beam may be a divergent, collimated or focused beam.

The diffusor 32 may basically a half-shell including a circular wing structure 32. Since the batwing intensity profile is preferably center symmetric around the axis of light propagation, the wing structure 32 may form a (center symmetric) crown 34 around the apex of the diffusor 30. However, in some embodiments, the wing structure 32 may be non-center symmetric to provide a non-center symmetric batwing intensity profile, i.e., a batwing intensity profile optimized only for at least one specific spatial direction. This may be useful for specific applications in which the illumination light has to be directed only to a very limited region. The interior 36 of the half-shell-shaped diffusor 30 is preferably filled with a solid index material. However, also gaseous or liquid index materials may be used. The interior 36 of the half-shell-shaped diffusor 30 may also be non-filled (evacuated) or the interior 36 is integrally formed with the material of the half-shell-shaped basic structure (hemispherical structure).

The exemplarily batwing intensity profile according to the present invention under b) shows the relative intensity for zenithal angles of a surround-view imaging system according to the present invention in a cross-section. The typical “bat-wing” starts at around a zenithal angle φ of 40°, ends at an zenithal angle φ of around 110° and reaches its maximum at an zenithal angle φ of around 85°. The full width half maximum (FWHM) value of the “bat-wing” profile is around 40°. It is noted that the graph does not refer to the batwing intensity profile directly generated by an diffusor according to the present invention but represents the final intensity distribution in the FOV of the illuminator. However, apart from the specifically demonstrated angular dependence, the general structure of a batwing intensity profile can clearly be seen.

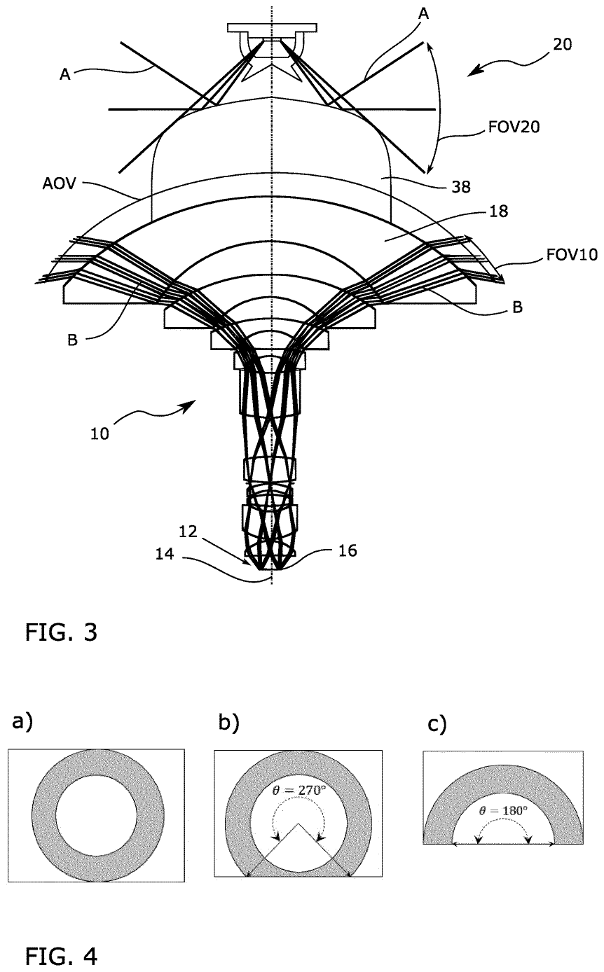

FIG. 3 shows a schematic illustration of exemplarily embodiment of a surround-view imaging system according to the present invention. The surround-view imaging system comprises an imager 10 and an illuminator 20; wherein the illuminator 20 is adapted to illuminate in a field of view of the illuminator FOV20 the surrounding of the system such that illumination light A that is reflected by the surrounding can be imaged by the imager 10 in a field of view of the imager FOV10 as imaging light B, wherein the illuminator 20 and the imager 10 are arranged one over another in a vertical direction parallel to a vertical axis 14 of the system, wherein the system is configured to allow circumferential imaging in a horizontal plane perpendicular to the vertical axis 14 in the field of view of the imager FOV10.

The illuminator 20 comprises a light source 24 and a diffusor 30 that provides the illumination light A with a batwing intensity profile, wherein the illumination light A is directed towards the imager 10 in the vertical direction; and a deflector 38 positioned between the light source 24 and imager 10 in the vertical direction, configured to redirect the illumination light A from the vertical direction to essentially a horizontal direction in the field of view of the imager FOV10, wherein the field of view of the illuminator FOV20 and the field of view of the imager FOV10 may at least partly overlap in the surrounding.

The imager 10 corresponds to the embodiment shown in FIG. 1, however, the invention is not limited to such an embodiment and other system designs compatible with the general idea of the invention as defined by the appended claims may be implemented instead. The same considerations apply to the light source 24 and the diffusor 30, which corresponds to the embodiment shown in FIG. 2a. The reference signs are coherently used in FIGS. 1 and 2, therefore they will not be explained in detail here.

The illuminator 20 may be arranged above a lens 18 of the imager 10 in the vertical direction, wherein field of view of the lens 18 and the deflector 28 may comprise an azimuthal angle θ of 360° in the horizontal plane. The batwing intensity profile of the diffusor 30 and an angle-dependence of the deflection of the deflector 38 may be configured such that an essentially homogeneous illumination of the field of view of the imager FOV10 may be cooperatively achieved. The diffusor 30 and the deflector 38 may be configured to prevent directly scattered illumination light A from entering the imager 10. In a preferred embodiment, the intensity of the illumination light in the field of view of the illuminator FOV20 may have a maximum at an azimuthal angle θ between of 80° and 90° and a full width at half maximum (FWHM) azimuthal angle Δθ_{FWHM} between 10° and 40°. Preferably, a projection of the surrounding on an image plane (detector plane) 16 can be adjusted to different ROI.

FIG. 4 shows schematic illustrations for using different alignments of the images on the detector to optimize image resolution and FOV of the imager of a surround-view imaging system. The projection of a scene on a detector can be adjusted to obtain smaller, but higher resolution horizontal/vertical FOV. While in example a) the FOV of the imager is fully imaged on the active surface of the detector, example b) shows an alignment in which the horizontal FOV is slightly reduced to 0=270° at a detector having an active surface of the same size. Under c) another example with a smaller detector and different aspect ratio is shown. On this specific detector the horizontal FOV is even more reduced to 0=180°. However, the full vertical FOV can still be covered by the detector.

### REFERENCE LIST

10 imager
12 image detector/plane
14 optical/vertical axis
16 image
18 lens (e.g., 360° lens as first lens of a lens system)
20 illuminator
22 substrate
24 light source
30 diffusor
32 wing structure
34 crown
36 interior
38 deflector
θ azimuthal angle (related to the horizontal field of view, e.g., 360°)
φ zenithal angle (related to the vertical field of view, e.g., between 60° and 120°)
A illumination light
B imaging light
AOV angle of view
FOV10 field of view of the imager
FOV20 field of view of the illuminator

1. A surround-view imaging system for imaging a surrounding of the system, comprising:
an imager and an illuminator; wherein the illuminator is adapted to illuminate in a field of view of the illuminator the surrounding of the system such that illumination light that is reflected by the surrounding can be imaged by the imager in a field of view of the imager as imaging light, wherein the illuminator and the imager are arranged one over another in a vertical direction parallel to a vertical axis of the system, wherein the system is configured to allow circumferential imaging in a horizontal plane perpendicular to the vertical axis in the field of view of the imager;
wherein the illuminator comprises:
a light source and a diffusor that provide the illumination light with a batwing intensity profile, wherein the illumination light is directed towards the imager in the vertical direction; and
a deflector positioned between the light source and imager in the vertical direction, configured to redirect the illumination light from the vertical direction to essentially a horizontal direction in the field of view of the imager, wherein the field of view of the illuminator and the field of view of the imager at least partly overlap in the surrounding.

2. The surround-view imaging system of claim 1, wherein the illuminator is arranged above a lens of the imager in the vertical direction, wherein field of view of the lens and the deflector preferably comprise an azimuthal angle θ of 360° in the horizontal plane.

3. The surround-view imaging system of claim 1, wherein the diffusor is arranged above an emitter surface of a semiconductor light source.

4. The surround-view imaging system of claim 1, wherein the diffusor is configured for converting a circular input beam into a substantially annular output beam, wherein a maximum intensity in an annular region of the output beam having high intensity is exceeding a maximum intensity in a central region of the annular output beam having low intensity by at least a factor of 2.

5. The surround-view imaging system of claim 4, wherein the diffusor is basically a halfshell including a circular wing structure forming a crown around an apex of the diffusor, wherein an interior of the halfshell shaped diffusor is preferably filled with a solid index material.

6. The surround-view imaging system of claim 1, wherein an outer shape of the deflector corresponds to that of a cone section or is a freeform shape.

7. The surround-view imaging system of claim 1, wherein the batwing intensity profile of the diffusor and an angle-dependence of a deflection of the deflector are configured such that an essentially homogeneous illumination of the field of view of the imager is cooperatively achieved.

8. The surround-view imaging system of claim 1, wherein the diffusor and the deflector are configured to prevent directly scattered illumination light from entering the imager.

9. The surround-view imaging system of claim 1, wherein the intensity of the illumination light in the field of view of the illuminator has a maximum at an azimuthal angle θ between of 80° and 90° and a full width at half maximum azimuthal angle Δθ_{FWHM} between 10° and 40°.

10. The surround-view imaging system of claim 1, wherein an image detector may have an active detection region which is adapted to an image size or a specifically defined region of interest.

11. The surround-view imaging system of claim 4, wherein the diffusor is an diffractive optical element.
